(19) United States
(12) Patent Application Publication
(10) Pub. No.: US 2005/0001030 A1
(43) Pub. Date: Jan. 6, 2005

(54) Method and system for information display using a multimedia device employing a powerline modem

(76) Inventor: Marc L. Allen, Chesapeake, VA (US)

Correspondence Address: NIXON PEABODY, LLP, 401 9TH STREET, NW, SUITE 900, WASHINGTON, DC, 20004-2128, US

(21) Appl. No.: 10/840,614

(22) Filed: May 7, 2004

Related U.S. Application Data
(63) Continuation-in-part of application No. 10/137,375, filed on May 3, 2002.
(60) Provisional application No. 60/288,329, filed on May 4, 2001.
(60) Provisional application No. 60/468,252, filed on May 7, 2003.

(51) Int. Cl. G06K 5/00; G06K 15/00

(52) U.S. Cl. 235/383

(57) ABSTRACT

A method and system of displaying information, including sensing at least an identification code on one or more identification-carrying devices; using a powerline modem to transmit the identification code and information display system identification information from information display system to an informational server; receiving at least the identification code and the information display system identification information at the information server; determining one or more portions of information to be displayed on an information display system based on the identification code and the information display system identification information; and receiving via the powerline modem and conveying the one or more portions of information at the information display system.

### CROSS-REFERENCE TO RELATED CASES

The present invention claims benefit of priority under 35 U.S.C. §119(e) to U.S. Provisional Patent Application Ser. No. 60/468,252, filed May 7, 2003, entitled “Powerline RFID Media Device,” and is a Continuation-in-Part application of commonly-assigned, co-pending, U.S. patent application Ser. No. 10/137,375, filed May 3, 2002, entitled “System and Methods for the Identification and Displaying of Information,” which claims benefit of U.S. Provisional Patent Applications Ser. No. 60/288,329, filed May 4, 2001, entitled “Customer Identifying Coupon Printer,” the entire disclosures of all of which are hereby incorporated by reference herein.

### BACKGROUND OF THE INVENTION

1. Field of the Invention

The present invention generally relates a methods and systems for display of information, and more particularly to a system and method for distribution of information via a multimedia device and a powerline modem.

2. Discussion of the Background

In recent years, multimedia devices have become popular as mini advertising and information kiosks. They entertain and interact with customers, particularly those in a captive situation, such as waiting in line for groceries, purchasing tickets, or filling a gasoline tank at a service station.

Also, with the advent of computerized point of sale terminals, loyalty systems have been incorporated with point of sale terminals and loyalty systems in order to dispense a reward to customers for frequent use of a company's services, frequent purchases of a company's goods, or the like. Frequent flyer miles are a prime example of how airlines reward passengers for traveling on their airline. The reward, based on the number of “miles” accumulated, can vary from discounts on future airline ticket purchases, to seat upgrades, free tickets, or the like.

Likewise, grocery stores often implement a coupon-printing scheme whereby customers are given a coupon that is redeemable for future purchases after purchasing a particular product. For example, during scanning of a particular brand of tooth paste at the checkout counter, a printer associated with the cash register, produces a coupon redeemable against the next purchase of a related mouthwash product. In this example, the triggering event for the printing of the coupon is the scanning, i.e., purchase, of a particular product. However, the generation of this coupon is independent of the identity and preferences of the user, or customer. For example, the user may not use mouthwash. Therefore, the printing of that particular coupon did not accomplish its intended purpose, the sale of another related product.

Retail stores computerized inventory systems are usually integrated with point-of-sale terminals for automatic updating of inventory. Inventory systems are known to be continuously connected to a central master system via for example LAN and WAN, using leased optical or non-optical lines, satellite transceiver, DSL, cable, etc. Inventory systems are also known to connect to a central master system on a periodic basis via a telephone modem. However, associated with these known systems are relatively high cost of installation of networking equipments, which may include expensive cable installations.

### SUMMARY OF THE INVENTION

In view of the above, there exists a need for an information display system used, for example, in a loyalty system, to provide information, such as coupons, based on their loyalty, purchasing habits, personal preferences, or the like. In particularly, there is a need for integration of the information display system with a central information server or related systems that offers the right balance of cost, convenience and speed without using the aforementioned connection methods. In order to provide a cost-effective, convenient, and sufficiently high speed system and method for a multimedia device for merchandising which interfaces with a central coordination device, it is an exemplary embodiment of the present invention to advantageously combine a powerline modem with the multimedia device and a central coordination device.

Accordingly, in an exemplary aspect of the present invention there is provided a method and system of displaying information, including sensing at least an identification code on one or more identification-carrying devices; using a powerline modem to transmit the identification code and information display system identification information from information display system to an informational server; receiving at least the identification code and the information display system identification information at the information server; determining one or more portions of information to be displayed on an information display system based on the identification code and the information display system identification information; and receiving via the powerline modem and conveying the one or more portions of information at the information display system.

Still other aspects, features, and advantages of the present invention are readily apparent from the following detailed description, by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 is a functional block diagram illustrating an exemplary embodiment of the information display system according to this invention;

FIG. 2 is a flowchart illustrating an exemplary method of displaying information according to this invention;

FIG. 3 is a flowchart illustrating an exemplary method of selecting information according to this invention;

FIG. 4 is a flowchart illustrating an exemplary method of managing an account according to an exemplary embodiment of this invention; and

FIG. 5 is a functional block diagram illustrating another exemplary embodiment of the information display system with powerline modem interface according to this invention.

### DETAILED DESCRIPTION OF THE PREFERRED EMBODIMENTS

The exemplary embodiments will be described in relation to methods and systems for distribution of information via a multimedia device and a powerline modem. However, to avoid unnecessarily obscuring the present invention, the following description omits well-known structures and devices that may be shown in block diagram form or otherwise summarized. For the purpose of explanation, numerous specific details are set forth in order to provide a thorough understanding of the present invention. It should be appreciated however that the present invention may be practiced in a variety of ways beyond the specific details set forth herein. For example, the systems and methods of this invention can be scaled to any level and are capable of working in conjunction with various types of customer and already existing systems.

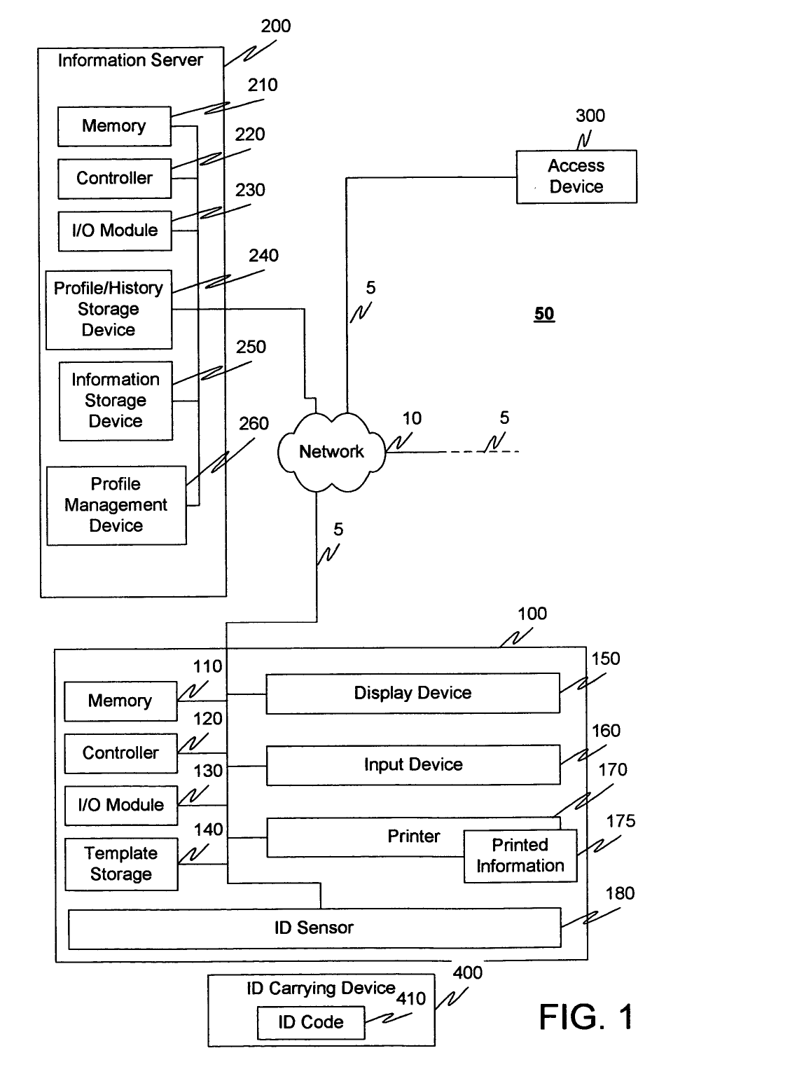

Referring now to the drawings, wherein like reference numerals designate identical or corresponding parts throughout the several views and more particularly to FIG. 1 thereof, there are illustrated an exemplary information display system 50. In FIG. 1, the exemplary information display system 50 comprises an information display device 100, an information server 200, and an access device 300, for example, interconnected by a network 10 and one or more links 5. The information display device 100 comprises a memory 110, a controller 120, an I/O module 130, a template storage 140, a display device 150, an input device 160, a printer 170 that outputs printed information 175, and an identification sensor (ID sensor) 180. The information display device 100 further communicates with an identification-carrying device 400 that stores one or more identification codes 410.

The information server 200 comprises a memory 210, a controller 220, an I/O module 230, a profile and history storage device 240, an information storage device 250 and a profile management device 260.

Using the system of FIG. 1, an individual can identify themselves to an information display device, such as a coupon printer, using, for example, an identification-carrying device that contains a unique identification code. The identification code is associated with a particular profile that identifies, for example, customer loyalty, preference and history data that may be associated with a particular user. An identification sensor senses the identification code on the identification-carrying device. The identification code is then forwarded via, for example, a local information display device, to an information server. The information server uses the identification code, and possibly additional information such as an identification of the information display device, to access loyalty and preference data associated with the identification code. This information can include, for example, coupons that have been issued to the user associated with the identification code, a user's preferences, a user's purchase history, or the like.

Based on one or more of the above, the information server determines and forwards information, such as coupon information, back to the information display device which can then, for example, print the coupon for the user. The information can be, for example, anything from coupon parameters used to create a coupon to a fully formatted coupon ready for immediate printing. For example, the information display device, which can include a coupon printer, may be separate from any other form of customer interaction, such as point-of-purchase terminals, gasoline dispensers, ATM's, or the like. Thus, while the information can be associated with a particular user interaction, the information can, for example, also be independent of any transactions that may have occurred at the same location.

While the exemplary embodiments illustrated herein show the various components of the information display system collocated, it is to be appreciated that the various components of the information display system can be located at distant portions of a distributed network, such as a local area network, a wide area network, a telecommunications network, an intranet and/or the Internet, or within a dedicated information display system. Thus, it should be appreciated that the components of the information display system can be combined into one or more devices or collocated on a particular node of a distributed network, such as a communications network. As will be appreciated from the following description, and for reasons of computational efficiency, the components of the information display system can be arranged at any location within a distributed network without affecting the operation of the system.

Furthermore, it should be appreciated that the various links connecting the elements can be wired or wireless links, or any combination thereof, or any other know or later developed element(s) that is capable of supplying and/or communicating data to and from the connected elements. Additionally, the term module as used herein, denotes any piece of hardware, software, or combination thereof is capable of performing the functions associated with that element.

In operation, the identification-carrying device 400 is placed within the sensible area of the identification sensor 180. Upon the identification sensor 180 sensing one or more identification codes stored within the identification-carrying device 400, the information display device 100 forwards the one or more identifications, as well as any other relevant information, to the information server 200. The information server 200 determines, for example based on the one or more identifications and, for example, an identification of the information display device 100, the information, if any, to be returned to the information display device 100 for display. Upon having made the determination, the information server 200 forwards to the information display device 100 all, a portion, or an identifier of information to be displayed on the information display device 100. The information display device 100 then displays the information, for example on the display device 150 and/or the prints the information 175 on the printer 170.

The identification-carrying device 400 can be any device that is capable of communicating with the identification sensor 180 in order to transfer information, such as the one or more identification codes 410, to the identification sensor 180. For example, the identification-carrying device 400 can communicate with the identification sensor 180 via a direct contact system, such as a magnetic strip and the identification sensor 180 a magnetic strip reader, an optical communication system, a radio frequency communication system or any other known or later developed electrical, inductive or capacitive based system that is capable of communicating the identification code to the identification sensor 180.

For example, the identification-carrying device 400 can be based on RFID (radio frequency identification) which typically operates in the frequency range of 60 KHz to 5.8 GHz. Common identification-carrying devices 400 operate at 900 KHz, 125 KHz, 13.56 MHz and 2.4 GHz. Examples of direct contact systems include the smartcard technology and magnetic strip readers. Optical systems can include, for example, barcode readers. Additionally, the identification-carrying device 400 can be integrated into a portion of a larger device, such as a wand or tag connected to a key chain. Examples of these devices are the Texas Instruments™. RFID tags, called “TIRIS”, the Phillips™. RFID tags, called “Mifair”, OTI RFID tags, Dallas Semiconductor's™ I-Button, or the like. Examples of smartcards, such as those produced by Schlumberger can also be used.

Alternatively, the identification-carrying device 400 can be a device that is capable of being written to as well as read from. For example, while the exemplary embodiments discussed below illustrate an embodiment where the user profile is stored on the information server 200, it is to be appreciated that it is also possible to store one or more portions of a user's profile on the identification-carrying device, or on a combination of the information server 200 and the identification-carrying device 400.

Upon the identification-carrying device 400 being placed in the sensible area of the identification sensor 180, the identification code 410 is read from the identification-carrying device 400 and forwarded, with the cooperation of the I/O module 130, the controller 120 and the memory 110, via network 10 and links 5, to the information server 200. Furthermore, the information display device 100 can supplement the identification code 410 code with additional information, such as the identifier of the information display device 100, the local time, whether any goods and/or services were purchased, an identification of those goods/services, local weather information, or in general any information that may be useful in terms of determining the information, if any, to be returned to the information display system 100. For example, if it is raining a coupon for a car wash is probably not appropriate.

Upon the information server 200 receiving the identification code and one or more additional portions of information, the information server 200 determines, with the cooperation of the memory 210, the controller 220, the I/O module 230 and the profile storage device 240, the type of information, if any, to be returned to the information display device 100. For example, the profile storage device 400 can make the determination based on the current transaction, a history of transactions associated with the particular identification code, a reward based system such as the “frequent flyer miles” program, a promotion based on a customer loyalty program, or the like.

Upon determining the type of information to be forwarded to the information display device 100, the profile storage device 240 cooperates with the information storage device 250, as well as the memory 210, the controller 220 and the I/O module 230, to retrieve and forward the selected information to the information display device 100. For example, the information storage device 250 can contain information, such as printable coupons, multi-media presentations, an identification and populatable portions of a template, audio and/or video clips, or the like, which is forwarded for subsequent display and/or printing at the information display device 100. Alternatively, the profile storage device 240 can forward an identifier to the information display device 100. This identifier corresponds to one or more types of information stored on the information display device 100 that can be displayed to, for example, a user.

Upon receipt of the information, or an identification of the information to be displayed, the information is displayed at the information display device 100 in cooperation with the memory 110, the controller 120 the I/O module 130, and if appropriate, the template storage 140. For example, based on the type of information, the information display device 100 determines one or more appropriate devices for displaying the information. For example, multimedia information can be displayed on the display device 150. Alternatively, information such as coupons can be displayed on the display device and printed via the printer 170.

In addition to being able to display information, the information display device 100 can allow a user to interact with one or more of the information display device 100 and the information server 200 via the input device 160. While the input device 160 is shown as a separate component, it is to be appreciated that, for example, the display device 150 and the input device 160 can be combined into one element, such as a touch screen. Alternatively, the input device 160 can be independent buttons such as, a “yes” and “no” buttons, or the like. Additionally, the input device can be speech activated and based on, for example, speech recognition and a voice driven menu and selection system.

Therefore, there are at least three modes of operation for the information display device 100. In a first mode, information is directly printed via the printer 170. In a second mode, and for example in conjunction with the display device 150, the user is prompted as to whether they would like to receive a print-out of selected information. For example, a preview of the information available to the user can be shown on the display device 150. If the user decides to receive a print-out of the information, the user selects, via a print button on input device 160, to print the information. Alternatively, the user can opt not to receive a print-out of the information and perhaps just view it on the display device 150. Thirdly, and again in conjunction with the display device 150 and the input device 160, the user can optional navigate through a variety of types of information that are available. If a printable version of the information is desired, the user can select, via the input device 160, to print that information. For example, if the information available to a user includes a coupon for a sandwich, a coupon for a car wash and coupon for a free gallon of gasoline, the user can select the coupon most appropriate for their needs.

The template storage device 140 is capable of storing one or more templates that can be used in association with the information server 200 for displaying information on one or more of the display device 150 and the printer 170. For example, the template storage 140 can store basic populatable coupon templates. Thus, the information server 200 can forward to the information display device 100 the information to be inserted into these templates. Then, with the cooperation of the controller 120 and the memory 110, the information from the information server 200 is merged with one or more templates in the template storage 140 and displayed. The templates can include printer templates, audio templates, video templates and/or multimedia templates.

Aside from the functionality associated with the user obtaining specific information associated with a particular identification code, the systems and methods of this invention also allow a user to create, manage and/or update their user profile, via, for example, access device 300. In particular, a user's profile is stored in the profile storage device 240. In general, the profile storage device 240 can contain any information about a user based on, for example, their associated identification code. For example, the profile storage device 140 can maintain an account of loyalty and/or rewards programs, user preferences, history logs, or any other information specific to a user.

A user accesses their profile with the access device 300. The access device 300 can be, for example, a computer, a PDA, a telephone, or the like. Alternatively, the access device 300 can be incorporated into the information display device 100. In general, the access device 300 allows a user to access, manage and manipulate one or more profiles stored in the profile storage device 240.

For example, and with the cooperation of the access device 300, a user enters their identification code, and, for example, a password. Upon authentication of the password, and in cooperation with the profile management device 260, the user is allowed to access portions of their profile. For example, the user can change their personal preferences regarding how they would like information to be displayed on the information display device 100. For example, a user can select that they always want have all available coupons printed, be queried whether they would like available coupons printed, to only show coupons for certain categories of goods, or the like. Furthermore, a user can access their profile to determine, for example, the number of points in a loyalty rewards program.

TABLE 1
shows various profile options available to a user.

| Display | Printing | Advertising | History | Ststus |
|---|---|---|---|---|
| Preferences | Preferences | Preferences | Preferences | Preferences |
| Query Before | Print All Coupons | Show No | Remember All | Show Current |
| Displaying | | Advertising | Transactions | Rewards |
| | | | | “Points” |
| Display All | Print All Coupons | Show Advertising | Remember No | Do Not Show |
| Information | For X | For X | Transactions | Status |
| Only Show | Query Before | Only Show | Only Remember | Alert When |
| Multimedia | Printing | Advertising For | Transaction If | Award |
| | | Local Merchant(s) | Associated With | Threshold |
| | | | A Rewards | Reached |
| | | | Program | |
| Only Show | Print Coupon | | Forward Rewards | |
| Information | Only If Similar | | History at | |
| About X | Coupon | | Predetermined | |
| | Previously | | Interval to | |
| | Redeemed | | Destination | |
| Show News | Only Print | | | |
| Feed | Coupons That Are | | | |
| | Instantly | | | |
| | Redeemable | | | |
| Show Weather | Only Print | | | |
| Feed | Coupons That Are | | | |
| | Instantly | | | |
| | Redeemable For | | | |
| | Purchased | | | |
| | Product | | | |

A user can also review a history of, for example, the coupons they have printed, the information they have viewed, and print reports detailing these transactions.

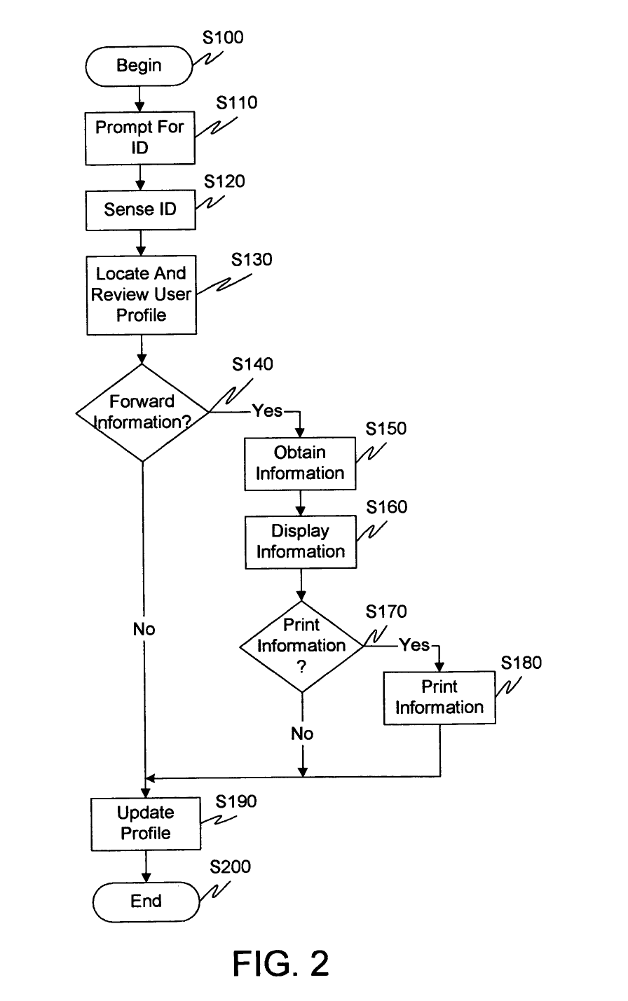

FIG. 2 outlines the exemplary operation of the information display system. In particular, control begins in step S100 and continues to step S110. In step S110, a user can optionally be prompted to place their identification-carrying device in the sensible area of the identification sensor. For example, the prompting can be based on an audio or video cue that could, for example, be triggered upon a user being within a certain proximity to an information display device. Next, in step S120, the identification code is sensed and retrieved from the identification-carrying device. Then, in step S130, the user profile, based on the sensed identification code is located and reviewed. Control then continues to step S140.

In step S140, a determination is made as to whether information should be forwarded to the user. For example, if the user profile specifies that the user would like to maintain a record of purchases for a rewards type system, but not receive any coupons or printed information, control would jump directly to step S190. If information is to be forwarded to the user, control continues to step S150.

In step S150, the appropriate information, or an identification of the information to be displayed, is obtained. For example, as discussed above, the determination of the information to be displayed can be dynamically determined based one or more portions of information. Next, in step S160, the information is displayed. Then, in step S170, a determination is made whether all or a portion of the information should be printed. For example, as discussed earlier, the determination can be based on query to the user or, for example, based a user's profile, or the like. If the information is to be printed, control continues to step S180 where the information is printed. Alternatively, the information can be printed or forwarded to one or more alternative or additional locations. For example, the user can specify in their profile that only coupons that are instantly redeemable should be forwarded to the printer. Other information or coupons that, for example, are not instantly redeemable, could be forwarded via mail, electronic and/or hard copy, to a destination specified in the user's profile. Control then continues to step S190.

Alternatively, if there is no desire to print the information, control jumps to step S190. In step S190, the user's profile is optionally updated. For example, as discussed previously, a user's history can be updated so as to, for example, log customers loyalty points, record a user's transactions, or the like. Control then continues to step S200 where the control sequence ends.

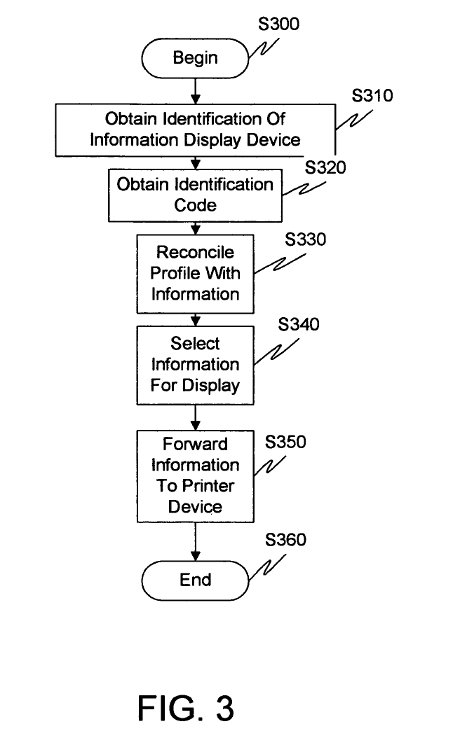

FIG. 3 outlines an exemplary method of selecting information according to this invention. In particular, control begins in step S300 and continues to step S310. In step S310, the identification code of the information display device can be optional obtained. For example, as discussed previously, in conjunction with the identification code of a user, the identification code for the information display device can also be used to aid in selecting the type of information to be presented to a user. Next, in step S320, the identification code is obtained.

In step S330, one or more of the information display device identification code and the identification code is reconciled with a user's profile information. Based on this reconciliation, in step S340, information is selected for display. Control then continues to step S350.

In step S350, the selected information is forwarded to the information display to be viewed, printed, or the like, by the user. Control then continues to step S360 where the control sequence ends.

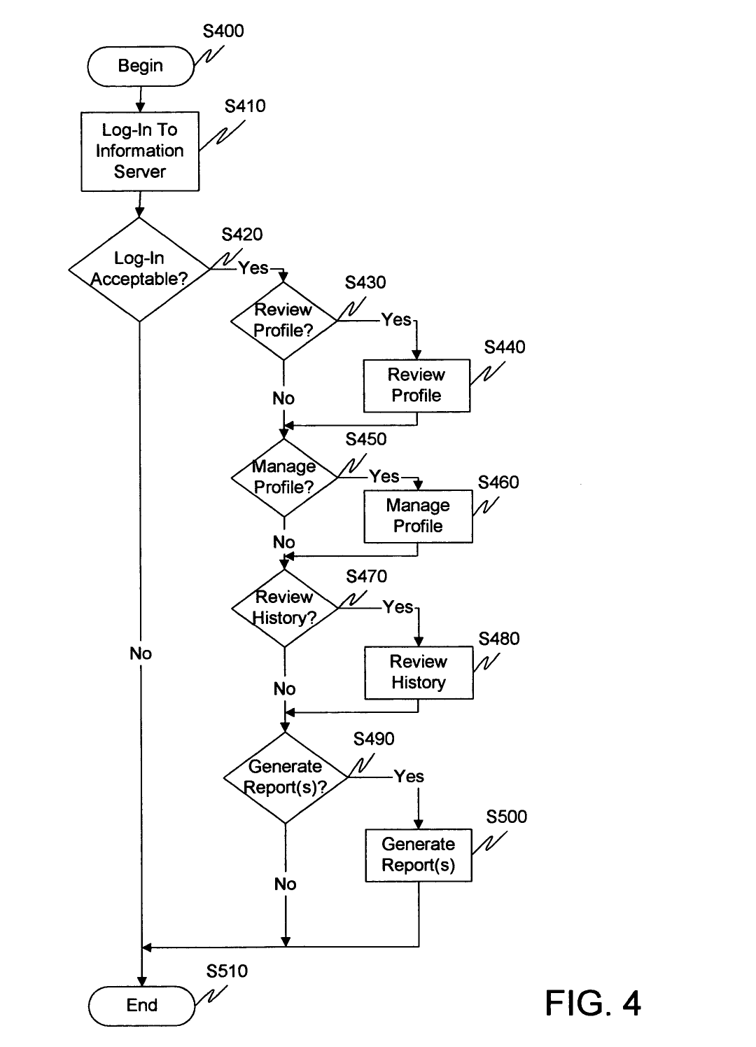

FIG. 4 outlines an exemplary method of accessing and managing a profile associated with an identification code according to an exemplary embodiment of this invention. In particular, control begins in step S400 and continues to step S410. In step S410 a user logs on to the information server. Next, in step S420, a determination is made as to whether the login was acceptable. If the login was acceptable, control continues to step S430. Otherwise, control jumps to step S510 where the control sequence ends.

In step S430, a determination is made as to whether the user would like to review their profile. If the user would like to review their profile, control continues to step S440 where a portion of the profile can be reviewed. Otherwise, control jumps to step S450. In step S450, a determination is made as to whether the user would like to manage their profile. If the user would like to manage their profile, control continues to step S460 where the used can modify/update a profile. Otherwise, control jumps to step S470.

In step S470, a determination is made as to whether the user would like to review their history. If the user would like to review their history, control continues to step S480 where the history can be reviewed, printed, or the like. Otherwise, control jumps to step S490.

In step S490, a determination is made as to whether the user would like to generate one or more reports. If the user would like to generate one or more reports, control continues to step S500 where the reports are generated. Otherwise, control jumps to step S510 where the controls sequence ends.

A typical loyalty system that could incorporate the above-described systems and methods of this invention could possible have other identification device readers associated with cash registers and gasoline dispensers, or the like, that are capable of accumulating loyalty and/or purchasing information that could also be assimilated with the systems and methods of this invention. For example, upon a user filling their car with fuel, the fuel pump loyalty system, cooperating with the systems and methods of this invention, could determine whether the user would desire a coupon for a car wash. Upon the systems and methods of this invention determining that the user received a coupon for a car wash yesterday that was redeemed, the system can determine if another type of coupon would be more appropriate, or determine that no coupon is necessary at this time. Alternatively, the system could query the user before the printing of the coupon to ensure that the coupon is desired.

For example, with the systems and methods of this invention, the user, such as a convenience store customer, is not necessarily required to accept any information, such as coupons, that they may be eligible for simple because they identify themselves to the information display system. Instead, the customer is allowed to obtain the information that they desire at a time when they desire through one or more of preferences and an input device that can obtain feedback from the user.

This allows, for example, added versatility in terms of how and what types of information can be provided. Specifically, a coupon need not be printed at the location it is earned. Thus, for example, by having the loyalty, preference and purchasing data held at a central location, loyalty preferences can be tracked at any location. For example, coupon printing can occur across many sites, such as in a chain of convenience stores. Many of the current loyalty systems either require the coupons to be printed at the moment they are earned or are created and maintained by an overall brand. Thus, these brand-based systems are location and brand specific.

In contrast, and in accordance with another exemplary advantage of this invention, the information display system can operate across a plurality of locations, for example, owned by a plurality of different entities, regardless of the brand association, or type of product and/or service sold.

The basic concepts associated with this invention can be expanded to be incorporated into identification sensing devices already present. For example, already existing identification sensors could forward and communicate with the information server according to the principles of this invention to allow a local printer or display device associated with the identification sensing device to print and/or display information, such as a coupon. For instance, a retail store's electronic cash register that supports RFID (Radio Frequency IDentification) may, for example, after having identified the customer, prompt the customer if they would like any available coupons, or a selected group of coupons, printed on the associated printer. Alternatively, the information, such as coupons, need not be physically printed, but an electronic version of the information, such as a coupon, can be forwarded and reconciled with, for example, an existing payment system.

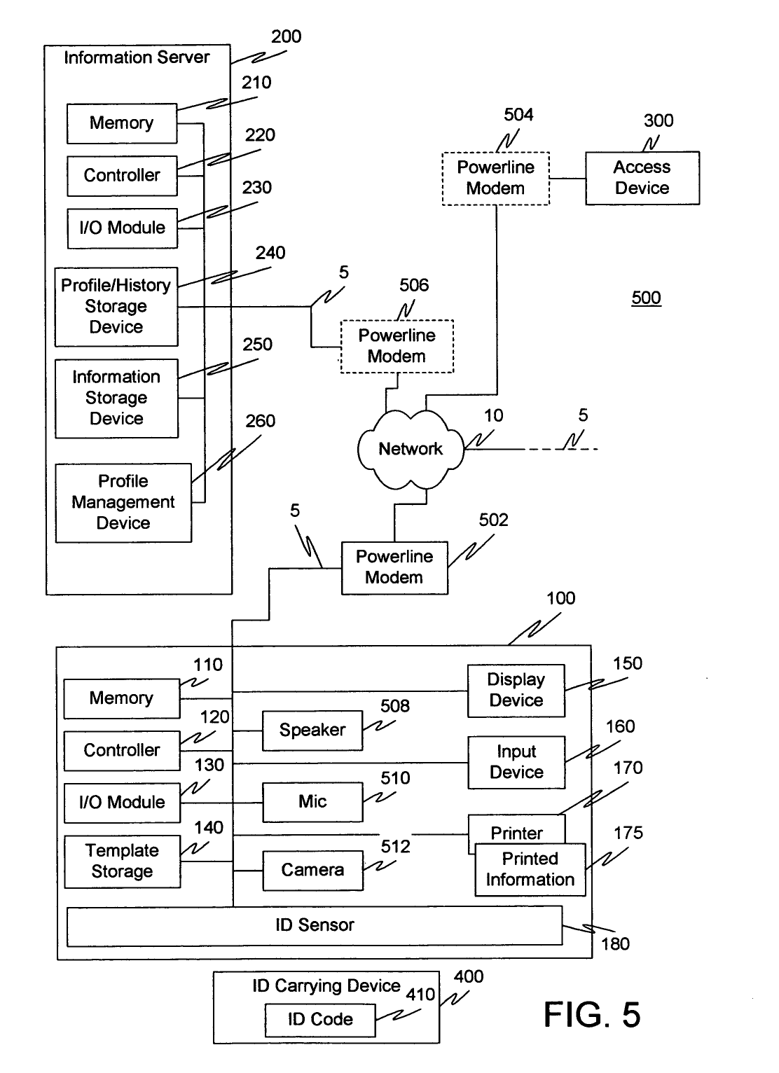

FIG. 5 illustrates a further exemplary system 500 according to an embodiment of the present invention. The embodiment illustrated in FIG. 5 includes a number of similar components found in the embodiment illustrated in FIG. 1 and discussed above. Therefore, for the sake of brevity and clarity, the similar features shared by both embodiments are shown with same numerical labels, and their descriptions are not repeated hereafter.

A powerline modem can include a device configured to modulate and demodulate data for digital bi-directional transmission over a common AC power line in the home, business, and electric power infrastructure. Powerline modems are capable of achieving a local data transmission rate of 100 Mbps, which is equal to many Ethernet LANs, and long-distance transmission rate of over 1 Mbps. Accordingly, a powerline can include any suitable devices capable of data transmission over electric power lines.

Using electrical lines and powerline modem, according to the exemplary embodiments, renders installation and service very convenient while achieving considerable cost-savings over aforementioned existing means as well as meeting the bandwidth requirement for audiovisual and data transmission. For example, there is no need for the bulky apparatus associated with wireless access. Connection between information display and a central coordinating device, for example, does not tie up phone lines like standard phone/modem connections, current implementations of cable TV services, or other phone line based services. Additionally, the system features constant access to the Internet, and much of the apparatus is already in place.

Further, in a typical wiring installation for connecting information display devices with a central coordinating device, for example, the cost of installing cables and associated hardware can add another 15-20% to the cost of the entire system, particularly in those locations where the kiosk or device is external to the primary facility, such as a gasoline station. Hence, this embodiment of the present invention as illustrated in FIG. 5 addresses the aforementioned problems.

As illustrated in FIG. 5, a powerline modem 502 is employed as a communication means between the information display device 100 and the information server 200. In FIG. 5, the information display device 100 interfaces with network 10 which in turn interfaces with information server 200, via a conventional communication means or via a powerline modem 506. To achieve similar cost-saving and convenience as in using powerline modems 502 and 506, powerline modem 504 can also be used to couple Access Device 300 to information Server 200 via Network 10.

Although various means can be employed for implementing a connection between various computers in a network, such as dedicated wired network, leased optical or non-optical line, satellite transceiver, etc., as previously described, using powerline modems allows the information display system of the present invention to interface with a central coordinating computer device system, while taking advantage of existing powerline infrastructure, as well as existing electrical wiring residences and businesses, advantageously, reducing the cost of installation.

The exemplary system 500 of FIG. 5 further includes the information display device 100 configured to employ audio speaker 508, microphone 510 and video camera 512. Motion sensing can be accomplished with video camera 512 to detect the presence of a customer, identify a customer, for example, by biometrics and facial recognition algorithm. Video camera 512 can also be utilized to control auto brightness of display device 150 and sound. For example, based on the camera's sensed information, display 150 can be put in a various modes, including, for example, brightness mode suitable for existing light conditions, or sleep-mode to reduce energy consumption and wear-and-tear.

Audio speaker 508 is used to deliver to customers audio information separately or in conjunction with the information displayed on display device 150. Audio information delivered can be for entertainment, such as music or advertisement, or informational, such as instructions, news, etc. Audio speaker 508 can be muted when no customer is present, or when a mute selection is selected by a user. Microphone 510 can be used to convey verbal communication between a customer and an operator, whether the operator can include a human being or a voice-recognition system.

With the incorporation of these audiovisual devices, real-time audio-visual information can be conveyed between customers and information server 200, a human operator (not shown), speech recognition system, and etc., associated with the operation of a business. The application of the audiovisual devices incorporated with the information display device 100 is not limited to the above-listed functions, but can be adapted to any suitable multimedia needs to the extent possible by programming their control and utilization.

Thus, the exemplary embodiments include employing a powerline modem in the integration of an information display device and a central coordination device, a multimedia information display for use in a loyalty system that includes a video display, a video camera, an audio speaker, a microphone, a printer, and an input device, presentation of specific data based on an identifier, such as an identification code, associated with a user and communicated between an information display device and a central coordination device via a powerline modem, printing of coupons and/or promotional material based on a sensed identification code, management of a profile associate with the identification code, management of a customer profile and preferences associated with a unique identification code which can, for example, be stored in an identification-carrying device, a coupon printer having an associated identification sensor for sensing an identification-carrying device, communicating user specific information to a centralized location via a powerline modem and determining display information based on the sensed identification code, determining presentation information based on a sensed identification code and an information display device identification, or the like. Advantageously, the exemplary embodiments minimize installation costs and help to provide a plug and play installation.

The present invention for selecting and displaying information, including interfacing a information display device with a central coordinating device via a powerline modem, can be implemented in conjunction with an already existing customer loyalty type system, a point-of-purchase system, or a separate programmed general purpose computer having a communications device. The present method can also be implemented in a special purpose computer, a programmed microprocessor or a microcontroller and peripheral integrated circuit element(s), an ASIC or other integrated circuit, a digital signal processor, a hardwired or electronic logic circuit such as a discrete element circuit, a programmable logic device, such as a PLD, PLA, FPGA, PAL, or the like, and associated communications equipment.

Furthermore, the disclosed method may be readily implemented in software using object or object-oriented software development environments that provide portable source code that can be used on a variety of computer, workstation or modem hardware and/or software platforms. Alternatively, the method may be implemented partially or fully in hardware using standard logic circuits or a VLSI design. Other software or hardware can be used to implement the methods in accordance with this invention depending on the speed and/or efficiency requirements of the system, the particular function, and the particular software and/or hardware or microprocessor or microcomputer(s) being utilized. Of course, the present method can also be readily implemented in hardware and/or software using any known later developed systems or structures, devices and/or software by those of ordinary skill in the applicable art from the functional description provided herein and with a general basic knowledge of the computer and telecommunications arts.

Moreover, the disclosed methods can be readily implemented as software executed on a programmed general purpose computer, a special purpose computer, a microprocessor and associated communications equipment, or the like. In these instances, the methods and systems of this invention can be implemented as a program embedded in an information display system, or the like. The methods can also be implemented by physically incorporating operational equivalents of the methods into software and/or hardware, such as a hardware and software system of an information display system, or the like.

While the present invention has been described in connection with a number of exemplary embodiments and implementations, the present invention is not so limited but rather covers various modifications and equivalent arrangements, which fall within the purview of the appended claims.

1. A method of displaying information, comprising:
sensing at least an identification code on one or more identification-carrying devices;
using a powerline modem to transmit the identification code and information display system identification information from information display system to an informational server;
receiving at least the identification code and the information display system identification information at the information server;
determining one or more portions of information to be displayed on an information display system based on the identification code and the information display system identification information; and
receiving via the powerline modem and conveying the one or more portions of information at the information display system.

2. The method of claim 1, wherein the information server is capable of determining the one or more portions of information independent of any sale transaction information.

3. The method of claim 1, further comprising displaying the one or more portions of information.

4. The method of claim 1, further comprising storing one or more templates that are combinable with the one or more portions of information.

5. The method of claim 1, further comprising storing a user profile in a profile storage device.

6. The method of claim 1, further comprising storing a user history in a history storage device.

7. The method of claim 1, further comprising allowing a user to manage a user profile.

8. The method of claim 1, wherein the one or more portions of information are dynamically determined based on at least one of a loyalty program, a user history, a current transaction, a past transaction, and a user profile.

9. The method of claim 8, wherein the user profile comprises preferences governing the one or more portions of information to be printed at the printer.

10. The method of claim 1, wherein the one or more portions of information are dynamically determined upon receipt of the identification code at the information server.

11. The method of claim 1, wherein the identification sensor and the identification-carrying devices are one or more of a radio frequency identification tag and a radio frequency identification reader, an optical code and optical code reader, magnetic strip and magnetic strip reader and an inductive, capacitive or electrical identification-carrying device and associated inductive, capacitive or electrical sensor.

12. The method of claim 1, wherein one or more of a user profile and a user history are associated with the one or more identification-carrying devices.

13. The method of claim 1, wherein the information server is capable of servicing a plurality of information display systems at geographically different locations.

14. The method of claim 1, further comprising determining type of information to be displayed on an information display system based on the identification code and the information display system identification information.

15. The method of claim 1, further comprises using the powerline modem to transmit audio and video data to the information display system for delivering audiovisual information based on the sensed identification code.

16. The method of claim 1, further comprising transmitting voice data between the information display system to the information server via the powerline modem.

17. A system of displaying information, comprising:
means for sensing at least an identification code on one or more identification-carrying devices;
means for using a powerline modem to transmit the identification code and information display system identification information from information display system to an informational server;
means for receiving at least the identification code and the information display system identification information at the information server;
means for determining one or more portions of information to be displayed on an information display system based on the identification code and the information display system identification information; and
means for receiving via the powerline modem and conveying the one or more portions of information at the information display system.

18. The system of claim 17, wherein the information server is adapted for determining the one or more portions of information independent of any sale transaction information.

19. The system of claim 17, further comprising means for displaying the one or more portions of information.

20. The system of claim 17, further comprising means for storing one or more templates that are combinable with the one or more portions of information.

21. The system of claim 17, further comprising means for storing a user profile in a profile storage device.

22. The system of claim 17, further comprising means for storing a user history in a history storage device.

23. The system of claim 17, further comprising means for allowing a user to manage a user profile.

24. The system of claim 17, wherein the one or more portions of information are dynamically determined based on at least one of a loyalty program, a user history, a current transaction, a past transaction, and a user profile.

25. The system of claim 24, wherein the user profile comprises preferences governing the one or more portions of information to be printed at the printer.

26. The system of claim 17, wherein the one or more portions of information are dynamically determined upon receipt of the identification code at the information server.

27. The system of claim 17, wherein the identification sensor and the identification-carrying devices are one or more of a radio frequency identification tag and a radio frequency identification reader, an optical code and optical code reader, magnetic strip and magnetic strip reader and an inductive, capacitive or electrical identification-carrying device and associated inductive, capacitive or electrical sensor.

28. The system of claim 17, wherein one or more of a user profile and a user history are associated with the one or more identification-carrying devices.

29. The system of claim 17, wherein the information server is adapted for servicing a plurality of information display systems at geographically different locations.

30. The system of claim 17, further comprising mean for determining type of information to be displayed on an information display system based on the identification code and the information display system identification information.

31. The system of claim 17, further comprises means for using the powerline modem to transmit audio and video data to the information display system for delivering audiovisual information based on the sensed identification code.

32. The system of claim 17, further comprising means for transmitting voice data between the information display system to the information server via the powerline modem.

33. The system of claim 17, wherein the means for sensing, means for using the powerline modem, means for receiving the identification code, means for determining, and means for receiving via the powerline modem comprise devices of a computer system.

34. The system of claim 17, wherein the means for sensing, means for using the powerline modem, means for receiving the identification code, means for determining, and means for receiving via the powerline modem comprise computer-readable instructions stored on a computer-readable medium.
